(19) United States
(12) Patent Application Publication
(10) Pub. No.: US 2018/0013909 A1
(43) Pub. Date: Jan. 11, 2018

(54) ELECTRONIC DEVICE AND POWER CONTROL METHOD

(71) Applicant: Tomoki YOSHIDA, Kanagawa (JP)

(72) Inventor: Tomoki YOSHIDA, Kanagawa (JP)

(73) Assignee: Ricoh Company, Ltd., Tokyo (JP)

(21) Appl. No.: 15/591,443

(22) Filed: May 10, 2017

(30) Foreign Application Priority Data
Jul. 8, 2016 (JP) 2016-136321

(51) Int. Cl. H04N 1/00; H04N 1/32

(52) U.S. Cl. CPC H04N 1/00891; H04N 1/32694; H04N 1/32667; H04N 1/00904; H04N 2201/0094; H04N 2201/3284

(57) ABSTRACT

An electronic device includes a controller coupled to a device via a signal line. The controller includes an outputter configured to output a predetermined signal to the device by using the signal line, when a predetermined abnormality occurs at the controller; and a power controller configured to control an operation of cutting off power supplied to the device, after a predetermined assurance time has passed from when the predetermined signal has been output.

### CROSS-REFERENCE TO RELATED APPLICATION

The present application claims priority under 35 U.S.C. §119 to Japanese Patent Application No. 2016-136321, filed on Jul. 8, 2016, the contents of which are incorporated herein by reference in their entirety.

### BACKGROUND OF THE INVENTION

### 1. Field of the Invention

The present invention relates to an electronic device and a power control method.

### 2. Description of the Related Art

For example, there is known an image forming apparatus such as a Multifunction Peripheral/Product (MFP) including a plurality of functions such as printing, copying, scanning, and fax transmission and reception, etc. For example, the image forming apparatus includes an engine unit for realizing functions such as printing and scanning, etc., a plurality of devices such as an operation panel for accepting operations by the user, and a controller unit for controlling the devices, etc.

Furthermore, there is known a technique applied to an image forming apparatus, in which the controller unit completes the ending processes at the respective devices to prepare for turning off the power, and then turns off the power of the devices, in order to safely turn off the power of the image forming apparatus (see, for example, Patent Document 1).
Patent Document 1: Japanese Unexamined Patent Application Publication No. 2011-170763

### SUMMARY OF THE INVENTION

An aspect of the present invention provides an electronic device and a power control method in which one or more of the disadvantages of the related art are reduced.

According to one aspect of the present invention, there is provided an electronic device including a controller coupled to a device via a signal line, the controller including an outputter configured to output a predetermined signal to the device by using the signal line, when a predetermined abnormality occurs at the controller; and a power controller configured to control an operation of cutting off power supplied to the device, after a predetermined assurance time has passed from when the predetermined signal has been output.

### BRIEF DESCRIPTION OF THE DRAWINGS

Other objects, features and advantages of the present invention will become more apparent from the following detailed description when read in conjunction with the accompanying drawings, in which:

FIG. 1 is an example of a hardware block diagram of an image forming apparatus according to an embodiment of the present invention;

FIG. 2 is an example of a software block diagram of the image forming apparatus according to an embodiment of the present invention;

FIG. 3 is an example of a functional block diagram of the image forming apparatus according to an embodiment of the present invention;

FIG. 4 is a sequence diagram indicating an example of a restart process according to a first embodiment of the present invention;

FIGS. 5A through 5C illustrate examples of the power off preparation signal according to the first embodiment of the present invention;

FIGS. 6A through 6C illustrate examples of the power control method of a device according to the first embodiment of the present invention;

FIG. 7 is a sequence diagram indicating an example of a process of acquiring the power off assurance time according to a second embodiment of the present invention;

FIG. 8 is a flowchart indicating an example of a process performed when an error occurs according to a third embodiment of the present invention;

FIG. 9 illustrates an example of an error display screen according to the third embodiment of the present invention; and

FIGS. 10A and 10B illustrate an example of a configuration of an electronic device according to another embodiment.

### DETAILED DESCRIPTION OF THE PREFERRED EMBODIMENTS

The technique of the related art disclosed Patent Document 1 enables the controller unit of the image forming apparatus to safely restart the image forming apparatus by collaborating with the respective devices.

However, by the technique disclosed Patent Document 1, for example, in a case where an abnormality occurs at the controller unit and the controller unit is no longer able to communicate with the respective devices, a problem arises in that the controller unit cannot collaborate with the devices to safely restart the image forming apparatus.

Note that the above problem is not limited to an image forming apparatus; the above problem is common to various kinds of electronic devices including one or more devices and a controller unit.

A problem to be solved by an embodiment of the present invention is that, in an electronic device including one or more devices and a controller unit, even when an abnormality occurs at the controller unit, the controller unit can collaborate with the respective devices to restart the electronic device.

Embodiments of the present invention will be described by referring to the accompanying drawings.

### <Hardware Configuration of Electronic Device>

Here, a description is given of a hardware configuration of an image forming apparatus including a plurality of functions such as printing, copying, scanning, and fax transmission and reception, as one example of an electronic device including one or more devices and a controller unit.

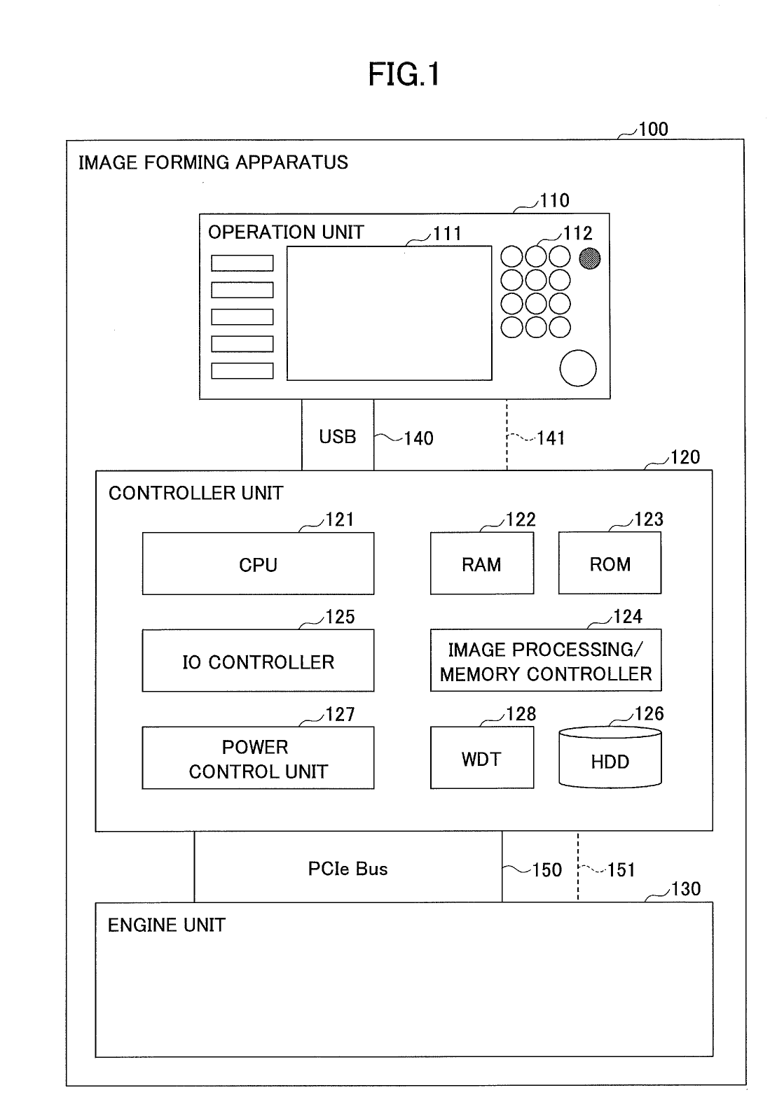

FIG. 1 is an example of a hardware block diagram of an image forming apparatus according to an embodiment. An image forming apparatus 100 includes an operation unit 110, a controller unit 120, and an engine unit 130, etc. The operation unit 110 and the controller unit 120 are communicatively coupled to each other by, for example, a Universal Serial Bus (USB) 140. Furthermore, the engine unit 130 and the controller unit 120 are communicatively coupled to each other by, for example, a Peripheral Component Interconnect Express (PCIe) bus 150.

Preferably, the controller unit 120 is coupled to the operation unit 110 by a signal line 141 for outputting a power off preparation signal described below. Furthermore, the controller unit 120 is coupled to the engine unit 130 by a signal line 151 for outputting the power off preparation signal.

Note that the controller unit 120 may use, for example, an existing signal line such as the USB 140, to output the power off preparation signal to the operation unit 110, instead of using the signal line 141. Similarly, the controller unit 120 may use an existing signal line such as the PCIe bus 150 to output power off signals to the engine unit 130, instead of using the signal line 151.

The controller unit 120 outputs the power off preparation signal to instruct the operation unit 110 and the engine unit 130, which are examples of one or more devices, to execute an ending process for shifting to a state where the power supplied to the devices can be cut off.

The controller unit 120 includes, for example, a Central Processing Unit (CPU) 121, a Random Access Memory (RAM) 122, a Read-Only Memory (ROM) 123, an image processing/memory controller 124, an Input/Output (IO) controller 125, a Hard Disk Drive (HDD) 126, a power control unit 127, and a Watch Dog Timer (WDT) 128, etc.

The CPU 121 is an arithmetic device for realizing functions of the controller unit 120 by, for example, executing programs stored in the ROM 123 and the HDD 126. The RAM 122 is a volatile memory used as a work area, etc., of the CPU 121. The ROM 123 is a non-volatile memory storing, for example, programs, etc., for activating the image forming apparatus 100.

The image processing/memory controller 124 is a hardware element for image processing, and executes various kinds of image processing operations executed in the image forming apparatus 100 (for example, compression, extension, expansion, reduction, and rotation, etc.).

The IO controller 125 is, for example, an Application Specific Integrated Circuit (ASIC), etc., including a CPU interface, a memory interface, a local bus interface, a PCIe bus interface, and a HDD interface, etc.

The HDD 126 is, for example, a large capacity storage device that stores data regardless of whether the power is turned on or off.

The power control unit 127 is a hardware element for controlling operations of supplying the power and cutting off the power with respect to the operation unit 110 and the engine unit 130, etc. For example, the programs executed by the CPU 121 may use the power control unit 127 to supply power or cut off power with respect to the operation unit 110 and the engine unit 130, etc.

The WDT 128 is a Watch Dog Timer, for example, for detecting that a program executed by the CPU 121 is not normally operating, and outputting signals such as reset signals.

By the above configuration, the controller unit 120 is able to control the entire image forming apparatus 100, including the operation unit 110 and the engine unit 130.

The operation unit 110 has a configuration of, for example, a general computer, and includes a display unit 111 for displaying an operation screen of the image forming apparatus 100 and an input unit 112 for accepting operations of the user, etc. Furthermore, the operation unit 110 may include a display input unit such as a touch panel display, etc., in which the display unit 111 and the input unit 112 are integrated.

The engine unit 130 is a hardware engine for realizing predetermined functions such as printing, scanning, and fax transmission, etc., provided by an electronic device such as an image forming apparatus, etc. The engine unit 130 includes, for example, a printer for printing images, a scanner for scanning images, and a Facsimile Control Unit (FCU) for performing fax transmission and reception.

Note that the operation unit 110 and the engine unit 130 are examples of one or more devices included in the electronic device. The engine unit 130 may be further divided into a plurality of devices such as a printer, a scanner, and an FCU, etc.

Furthermore, the image forming apparatus 100 is an example of an electronic device including the controller unit 120 that is coupled to one or more devices via a signal line. The image forming apparatus 100 may be another type of an electronic device such as an image projecting device, a remote conference device, an electronic whiteboard, and a digital camera, etc. In this case, the engine unit 130 includes hardware engines according to the functions included provided in the electronic device.

### <Software Configuration of Image Forming Apparatus>

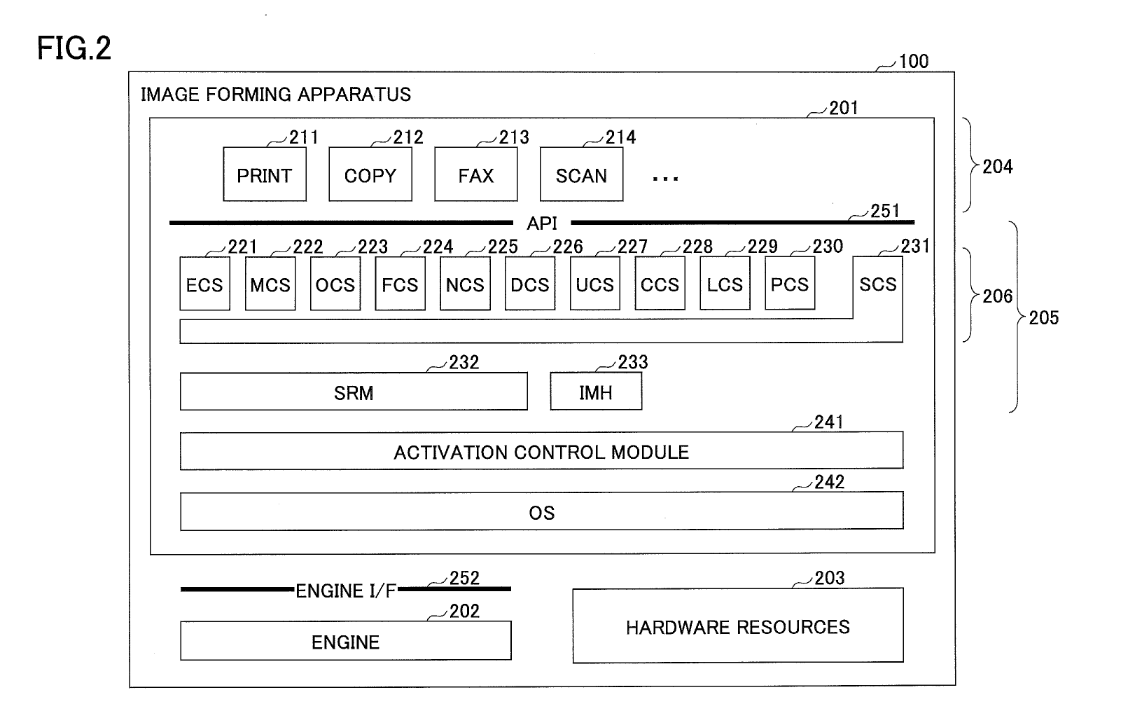

FIG. 2 is an example of a software block diagram of the image forming apparatus 100 according to an embodiment. The image forming apparatus 100 includes a software group 201, an engine 202, and hardware resources 203. Note that the engine 202 corresponds to the engine unit 130 of FIG. 1, etc., and the hardware resources 203 correspond to the IO controller 125 of FIG. 1, etc.

The software group 201 includes an application layer 204 and a platform 205 activated on an Operating System (OS) 242. For example, the application layer 204 includes application programs (hereinafter referred to as “applications”) such as PRINT 211, COPY 212, FAX 213, and SCAN 214, etc.

The PRINT 211 is an application for executing a printing process. The COPY 212 is an application for executing a copying process. The FAX 213 is an application for executing a fax process. The SCAN 214 is an application for executing a scanning process.

The platform 205 includes a service layer 206 that interprets a process request from the application layer 204 and generates a request to acquire the hardware resources 203, a System Resource Manager (SRM) 232 that manages the hardware resources 203 and regulates the acquisition request from the service layer 206, and an Image Memory Handler (IMH) 233 that assigns and manages memories, etc.

The service layer 206 includes a plurality of service modules such as an Engine Control Service (ECS) 221, a Memory Control Service (MCS) 222, an Operation Control Service (OCS) 223, a Fax Control Service (FCS) 224, a Network Control Service (NCS) 225, a Delivery Control Service (DCS) 226, a User Information Control Service (UCS) 227, a Certificate And Charge Control Service (CCS) 228, a Log Control Service (LCS) 229, a Power Control Service (PCS) 230, and a System Control Service (SCS) 231, etc.

Furthermore, the platform 205 includes an Application Programming Interface (API) 251 that enables the reception of a process request from the application layer 204 by a function defined in advance. The OS 242 executes the software items in the application layer 204 and the platform 205 in parallel as processes.

An activation control module 241 is a program that is executed first, for example, when the power of the image forming apparatus 100 is turned on and when the image forming apparatus 100 is restarted. By the activation control module 241, the OS 242 is activated and the application layer 204 and the platform 205 are activated.

The processes of the ECS 221 are performed for controlling the engine 202 and the hardware resources 203, etc. The processes of the MCS 222 are performed for controlling operations relating to the memory, such as acquiring and opening a memory and using the HDD 126, etc. The processes of the OCS 223 are performed for controlling the operation unit 110 that becomes an information transmitting means between the user and the main unit control.

The processes of the FCS 224 are performed for sending and receiving fax data requested from the application layer 204, registering various kinds of fax data managed in a back-up memory, loading fax data, reading fax data, and printing received fax data. The processes of the NCS 225 are performed for providing a network surface that can be commonly used, to the applications for sending and receiving data by the network. The processes of the DCS 226 are performed to control documents, such as distributing stored documents, etc.

The processes of the UCS 227 are performed for managing user information. The processes of the CCS 228 are performed for controlling operations relating to authentication and charging. The processes of the LCS 229 are performed for managing and holding log information. The processes of the PCS 230 are performed for controlling the power of the image forming apparatus 100, together with the IO controller 125 and the power control unit 127, etc., of FIG. 1. The processes of the SCS 231 are performed for managing applications, controlling the operation unit, displaying a system screen, LED display, managing hardware resources, and controlling interrupt applications, etc.

The processes of the SRM 232 are performed for controlling the system and managing the hardware resources 203 together with the SCS 231. For example, a process by the SRM 232 includes making regulations and controlling executions according to an acquisition request from a higher layer using the printer and the scanner, etc., included in the engine 202 and the hardware resources 203. The SRM 232 makes a process request to the engine 202 by using an engine interface (I/F) 252 that enables the transmission of the process request to the engine 202, etc., by a function defined in advance.

### <Functional Configuration>

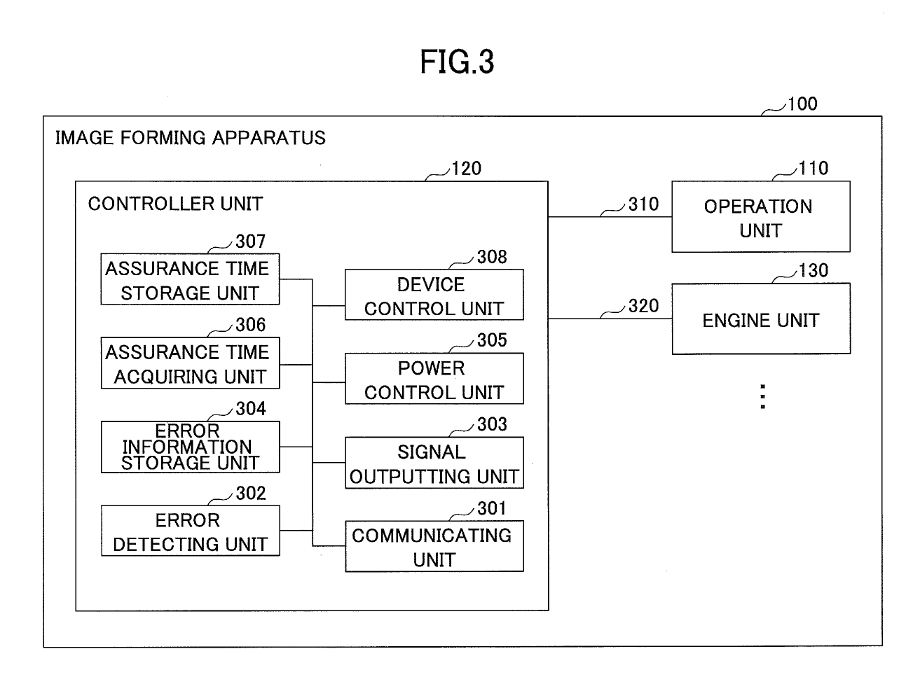

FIG. 3 is an example of a functional block diagram of the image forming apparatus 100 according to an embodiment. In FIG. 3, the image forming apparatus 100 includes the operation unit 110 and the engine unit 130 that are examples of one or more devices and the controller unit 120. The controller unit 120 is coupled to the operation unit 110 and the engine unit 130 via signal lines 310 and 320, respectively. The signal line 310 corresponds to, for example, the USB 140 and the signal line 141 of FIG. 1. The signal line 320 corresponds to the PCIe bus 150 and the signal line 151 of FIG. 1. Note that in the following descriptions, “device” may be used to refer to any device among the operation unit 110 and the engine unit 130 that are examples of devices.

The controller unit 120 includes a communicating unit 301, an error detecting unit 302, a signal outputting unit 303, an error information storage unit 304, a power control unit 305, an assurance time acquiring unit 306, an assurance time storage unit 307, and a device control unit 308, etc.

The communicating unit 301 is a means for the controller unit 120 to communicate with devices (the operation unit 110 and the engine unit 130, etc.) via the signal lines 310 and 320. The communicating unit 301 is realized by, for example, the IO controller 125, the ECS 221, and the OCS 223, etc.

The error detecting unit 302 is a means for detecting that a predetermined abnormality (error) has occurred at the controller unit 120. The error detecting unit 302 is realized by, for example, the PCS 230 or the WDT 128, etc.

A predetermined abnormality detected by the error detecting unit 302 includes, for example, a fatal error (or a grave error) detected at the kernel level (the OS 242 and the platform 205, etc.) of the image forming apparatus 100.

A fatal error (or a grave error) is, for example, an error that requires the restarting of the image forming apparatus 100 or the controller unit 120. For example, when the controller unit 120 can no longer communicate with an engine unit such as the operation unit 110 or the engine unit 130, and the image forming apparatus 100 cannot properly function anymore, it is determined that a fatal error (or a grave error) has occurred. In this case, for example, the controller unit 120 executes a process to restart the image forming apparatus 100 or the controller unit 120.

Furthermore, a predetermined abnormality detected by the error detecting unit 302 may include a case where the WDT 128, etc., detects that a program of the controller unit 120 is not operating normally.

The signal outputting unit 303 (outputter) outputs the power off preparation signal (predetermined signal) to the device by using the signal lines 310 and 320, when a predetermined abnormality occurs at the controller unit 120. The signal outputting unit 303 is realized by, for example, the PCS 230, the IO controller 125, and the WDT 128, etc.

Note that the power off preparation signal is a signal for the controller unit 120 to instruct the devices such as the operation unit 110 and the engine unit 130, etc., to execute an ending process such that the power supplied to the devices can be cut off. For example, when the operation unit 110 accepts the power off preparation signal from the controller unit 120, the operation unit 110 saves the necessary data in the RAM into a flash ROM, etc., according to need, and shuts down the operation unit 110. Furthermore, when a printer, which is an example of the engine unit 130, accepts the power off preparation signal from the controller unit 120, for example, the printer cancels the printing process and discharges a sheet that has been undergoing a printing process.

The error information storage unit 304 is a means for storing information of an error (abnormality) that may occur in the image forming apparatus 100 or the controller unit 120. The error information storage unit 304 is realized by, for example, the HDD 126 and the PCS 230. For example, the error information storage unit 304 stores, in advance, error information (for example, an error code, etc.) for identifying that a predetermined abnormality has occurred.

Preferably, the error information storage unit 304 stores, in advance, information indicating whether to restart the controller unit 120 (or the image forming apparatus 100) for every error that may occur at the controller unit 120 (or the image forming apparatus 100).

The power control unit 305 controls the operation of cutting off the power supplied to the device, after a power off assurance time has passed from when the power off preparation signal has been output to the device from the signal outputting unit 303. The power off assurance time is defined for each device in advance. The power control unit 305 is realized by, for example, the power control unit 127, the IO controller 125, and the PCS 230, etc.

Note that the power off assurance time is the time from when the device receives the power off preparation signal, to when an ending process is ended, to be in a state where the power can be safely cut off. For example, the power off assurance time is set in advance to be longer than the time required for the device to perform the ending process.

The assurance time acquiring unit 306 is a means for acquiring the power off preparation time from the respective devices. The assurance time acquiring unit 306 is realized by, for example, PCS 230.

The assurance time storage unit 307 is a means for storing the power off preparation time of the respective devices. The assurance time storage unit 307 is realized by, for example, the HDD 126 and the PCS 230. For example, the assurance time storage unit 307 stores the power off preparation time of the respective devices in advance. Furthermore, in another example, the assurance time storage unit 307 stores the power off preparation time acquired from the respective devices by the assurance time acquiring unit 306.

The device control unit 308 is a means for controlling the entire image forming apparatus 100. For example, after the power control unit 305 has cut off the power supplied to the respective devices, the device control unit 308 restarts the image forming apparatus 100. The device control unit 308 is realized by, for example, various services and applications including the PCS 230 and the activation control module 241.

By the above configuration, when an predetermined abnormality occurs at the controller unit 120, the controller unit 120 outputs the power off preparation signal to the respective devices, and after the power off assurance time of each device has passed, the controller unit 120 controls the operation of cutting off the power supplied to the respective devices. Furthermore, for example, after the power supplied to the respective devices (the operation unit 110 and the engine unit 130, etc.) is cut off, the controller unit 120 executes a process of restarting the image forming apparatus 100.

Furthermore, when the device such as the operation unit 110 or the engine unit 130 accepts the power off preparation signal output from the controller unit 120, the device executes a process of ending the device.

### <Process Flow>

Next, a description is given of a power control method and the process flow of a restart method according to an embodiment of the present invention.

### First Embodiment

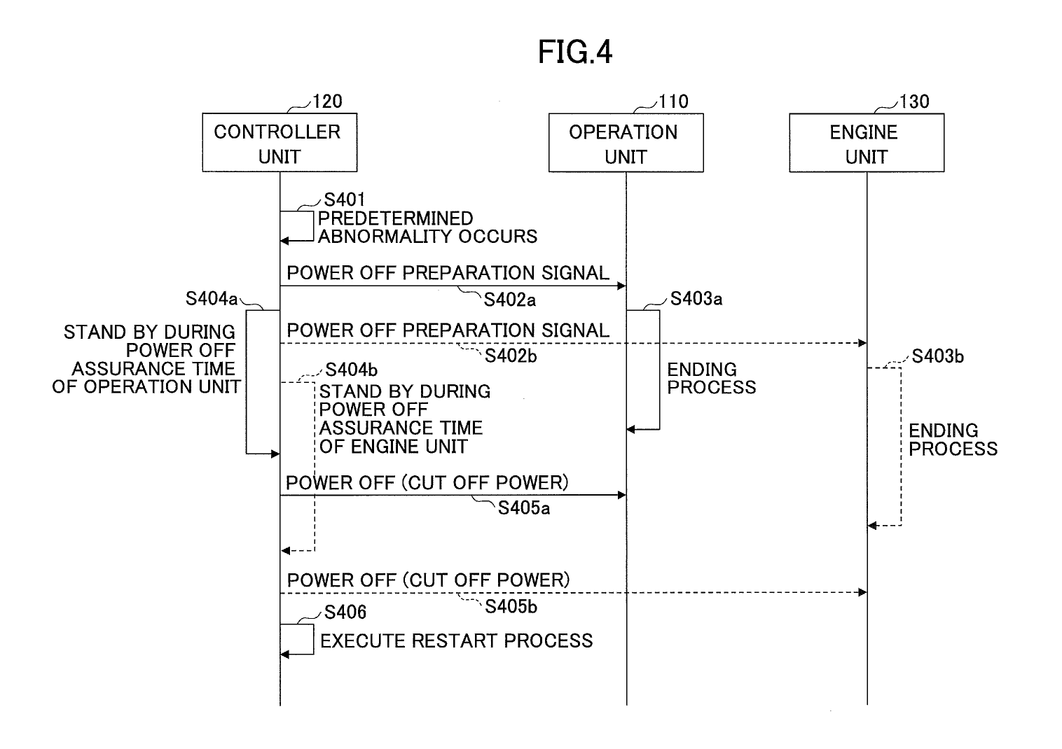

FIG. 4 is a sequence diagram indicating an example of a restart process according to a first embodiment.

In step S401, the error detecting unit 302 of the controller unit 120 detects that a predetermined abnormality has occurred at the controller unit 120 (or the image forming apparatus 100).

A predetermined abnormality includes, for example, a fatal error or a grave error that has occurred at the kernel level (the OS 242 and the platform 205, etc.) of the controller unit 120. A fatal error (or a grave error) is, for example, an error that requires the restarting of the image forming apparatus 100 or the controller unit 120.

In a preferable example, the error information storage unit 304 of the controller unit 120 may store, in advance, an error code of an error that requires a restart. Accordingly, the error detecting unit 302 will be able to easily determine whether the error that has occurred at the controller unit 120 is an error that requires a restart.

Furthermore, an error requiring a restart may include, for example, a case where the WDT 128 detects that a program executed at the controller unit 120 is not normally operating.

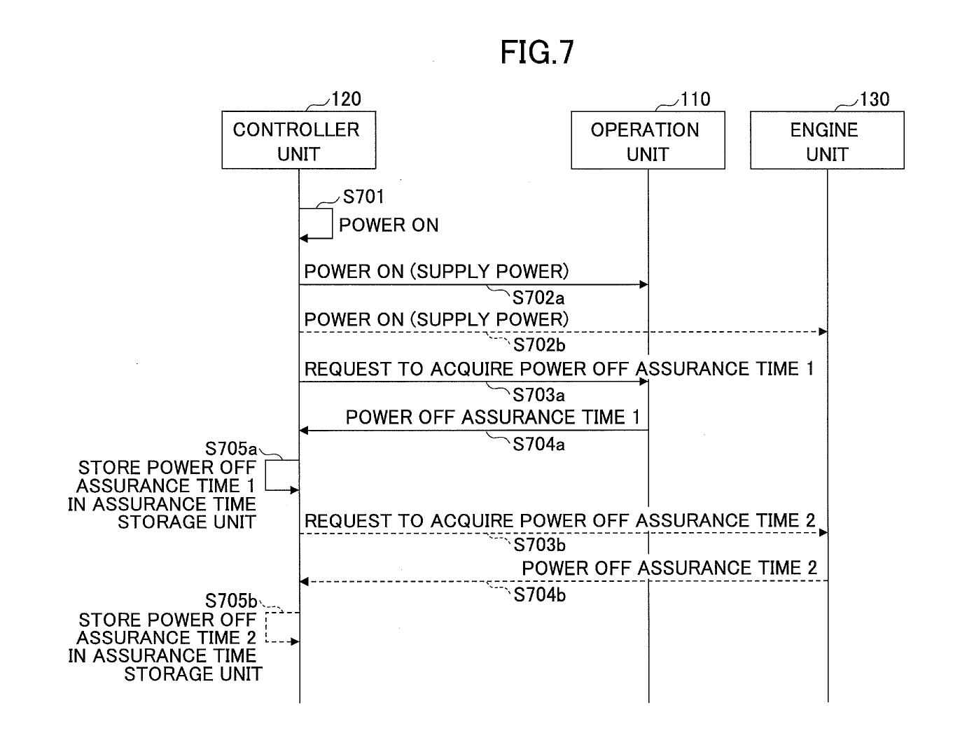

In step S402a, the signal outputting unit 303 of the controller unit 120 uses the signal line 310 to output the power off preparation signal (predetermined signal) to the operation unit 110. Furthermore, in step S402b, the signal outputting unit 303 uses the signal line 320 to output the power off preparation signal (predetermined signal) to the engine unit 130. Note that in FIGS. 4 and 7, the dashed line arrows indicate processes relating to the engine unit 130.

The power off preparation signal is a signal for the controller unit 120 to instruct the device (the operation unit 110 and the engine unit 130) to perform a preparation process for being prepared to cut off the power supply to the device (hereinafter referred to as “ending process”).

In a preferable example, the signal outputting unit 303 of the controller unit 120 outputs the power off preparation signal to the operation unit 110 by using the signal line 141 of FIG. 1, and outputs the power off preparation signal to the engine unit 130 by using the signal line 151 of FIG. 1.

Furthermore, in another example, the signal outputting unit 303 of the controller unit 120 may output the power off preparation signal by using existing signal lines such as the USB 140 and the PCIe bus 150, etc., of FIG. 1.

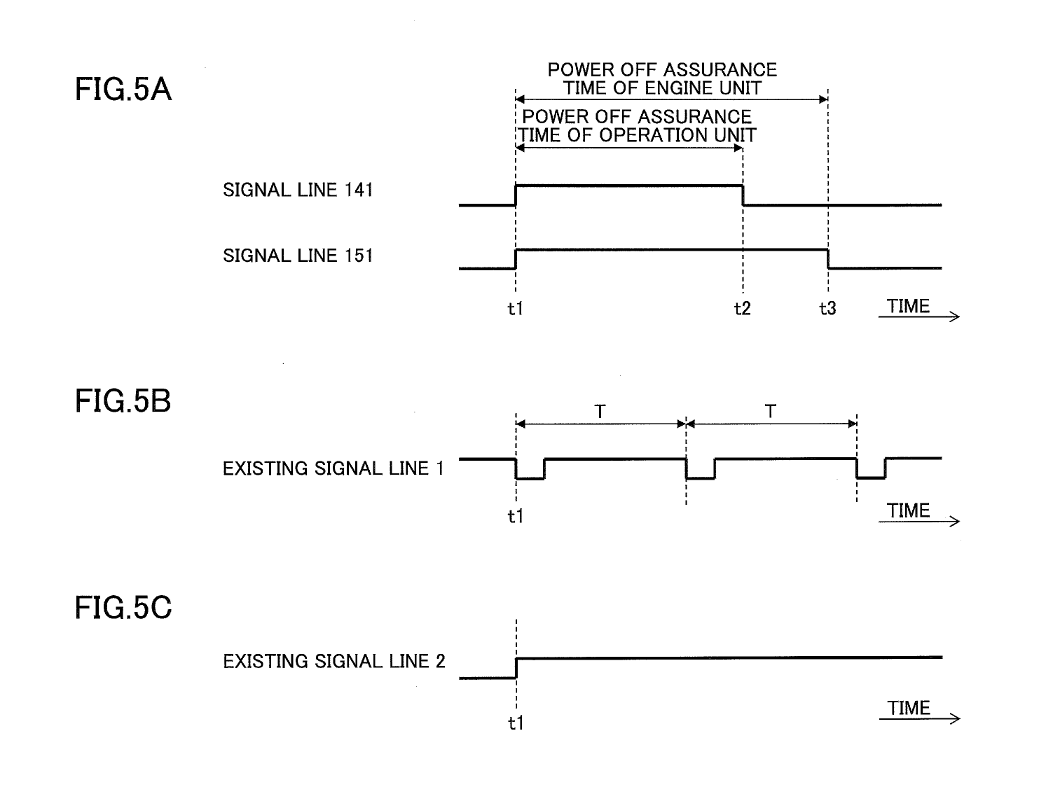

FIGS. 5A through 5C illustrate examples of the power off preparation signal according to an embodiment.

FIG. 5A illustrates an example of a power off preparation signal 1 output by the signal outputting unit 303 by using the signal lines 141 and 151. For example, at time t1 in FIG. 5A, the error detecting unit 302 of the controller unit 120 detects a predetermined abnormality. Then, the signal outputting unit 303 enables (asserts) the signal lines 141 and 151, and instructs the respective devices to execute an ending process. Note that the timing of disabling (de-asserting) the signal lines 141 and 151 by the signal outputting unit 303 may be any timing; for example, after the power off assurance time of the respective devices has passed, the signal outputting unit 303 disables the signal line 141 at a time t2, and disables the signal line 151 at a time t3.

FIG. 5B illustrates an example of a power off preparation signal 2 output by the signal outputting unit 303 by using an existing signal line 1. For example, at time t1 in FIG. 5B, the error detecting unit 302 of the controller unit 120 detects a predetermined abnormality. Then, the signal outputting unit 303 uses the existing signal line 1 to output signals of a predetermined pattern. The predetermined pattern may be any pattern as long as the pattern is defined in advance. In the example of FIG. 5B, L level pulses are output at a frequency T, as power off preparation signals.

FIG. 5C illustrates an example of a power off preparation signal 3 output by the signal outputting unit 303 by using an existing signal line 2. For example, at time t1 in FIG. 50, the error detecting unit 302 of the controller unit 120 detects a predetermined abnormality. Then, the signal outputting unit 303 inverts the logic of the existing signal line 2.

Note that the power off preparation signals illustrated in FIGS. 5A through 5C are examples. For example, as described above, the signal outputting unit 303 of the controller unit 120 may use exclusive-use signal lines 141 and 151 of FIG. 1 or an existing signal line to output the predetermined power off preparation signal to the respective devices.

Referring back to FIG. 4, the description of the sequence diagram is continued.

In step S403a, the operation unit 110 executes the ending process of the operation unit 110. For example, the operation unit 110 stores necessary data in the RAM into a flash ROM, etc., and performs the ending process of the OS.

In step S403b, the engine unit 130 executes the ending process of the engine unit 130. For example, when the engine unit 130 is a printer that is performing a printing process, the printer cancels the printing process and discharges the sheet.

In step S404a, the power control unit 305 of the controller unit 120 stands by during the power off assurance time of the operation unit 110, and subsequently in step S405a, the power control unit 305 cuts of the power supplied to the operation unit 110 (power off).

In step S404b, the power control unit 305 of the controller unit 120 stands by during the power off assurance time of the engine unit 130, and subsequently in step S405b, the power control unit 305 cuts of the power supplied to the engine unit 130 (power off).

Note that as the power off assurance time of each of the devices, for example, a longer time than the time required for the ending process of each device is set in advance, and the power off assurance time is stored in the assurance time storage unit 307 of the controller unit 120.

TABLE 1

| | POWER OFF | DEFAULT | |
|---|---|---|---|
| DEVICE | ASSURANCE TIME | VALUE | . . . |
| OPERATION UNIT | 15 SECONDS | 30 SECONDS | . . . |
| ENGINE | 60 SECONDS | 30 SECONDS | . . . |
| . | . | . | . |
| . | . | . | . |
| . | . | . | . |

Table 1 indicates an example of the power off assurance time of each device stored in the assurance time storage unit 307.

As indicated in Table 1, the assurance time storage unit 307 stores a power off assurance time set in advance (time set in advance) for each device. Note that the assurance time storage unit 307 may store in advance a default value that is used in a case where a power off assurance time of the device is not stored.

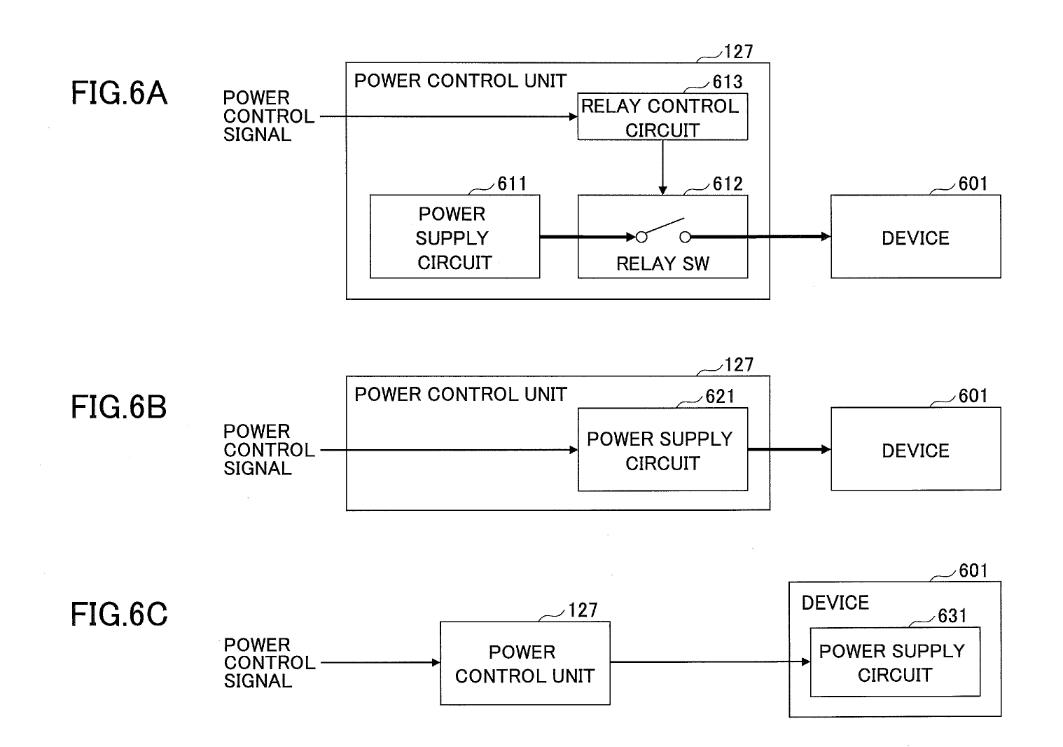

FIGS. 6A through 6C illustrate examples of the power control method of a device according to an embodiment.

FIG. 6A illustrates an example 1 of the power control method by the power control unit 305 of FIG. 3. In the example of FIG. 6A, the power control unit 127 of FIG. 1 includes a power supply circuit 611 for supplying power, a relay SW 612 for turning on and off the output of the power supplied to a device 601 by the power supply circuit 611, and a relay control circuit 613 for controlling the relay SW 612. In this example, the power control unit 305 switches between supplying power from the power supply circuit 611 to the device 601 and cutting off the power from the power supply circuit 611 to the device 601, by controlling the relay control circuit 613 with the use of a power control signal.

FIG. 6B illustrates an example 2 of the power control method by the power control unit 305 of FIG. 3. In the example of FIG. 6B, the power control unit 127 includes, for example, a power supply circuit 621 for each device 601. In this example, the power control unit 305 of FIG. 3 instructs to supply power from the power supply circuit 621 to the device 601 and to cut off the power from the power supply circuit 621 to the device 601 with the use of a power control signal.

FIG. 6C illustrates an example 3 of the power control method by the power control unit 305 of FIG. 3. In the example of FIG. 6C, the device 601 includes a power supply circuit 631 for supplying power within the device 601. In this example, the power control unit 305 of FIG. 3 outputs the power control signal to the device 601 via the power control unit 127 of FIG. 1, to instruct the power supply circuit 631 inside the device 601 to supply power and to cut off the power.

Note that the power control methods illustrated in FIGS. 6A through 6C are examples; other power control methods may be used as long as the power control unit 305 uses the power control signal to control the operations of supplying power to the device (the operation unit 110 and the engine unit 130, etc.) and cutting off the power supplied to the device. Furthermore, the power control signal output by the power control unit 305 is output, for example, according to the hardware control by the IO controller 125 and the power control unit 127, etc., of FIG. 1, or by the software control by the PCS 230 of FIG. 2.

Referring back to FIG. 4, the description of the sequence diagram is continued.

In step S406, the device control unit 308 of the controller unit 120 executes a process of restarting the image forming apparatus 100.

By the above process, when a predetermined abnormality is detected at the controller unit 120, the controller unit 120 outputs a power off preparation signal for instructing the devices (the operation unit 110 and the engine unit 130, etc.) to execute an ending process. Furthermore, after the power off assurance time set in advance for each device has passed from when the power off preparation signal has been output, the controller unit 120 cuts off the power supplied to each device.

Thus, according to the present embodiment, in the image forming apparatus 100 (an example of an electronic device) including one or more devices and the controller unit, when an abnormality occurs at the controller unit, the controller unit can collaborate with the one or more devices to restart the image forming apparatus 100.

### Second Embodiment

In the first embodiment, for example, as indicated in Table 1, the power off assurance time of each device is stored in advance in the assurance time storage unit 307. In a second embodiment, a description is given of an example of a process in which the controller unit 120 acquires the power off assurance time from each device, and stores the acquired power off assurance time in the assurance time storage unit 307.

FIG. 7 is a sequence diagram indicating an example of a process of acquiring the power off assurance time according to the second embodiment.

In step S701, the controller unit 120 switches to a power on state, for example, as the power of the image forming apparatus 100 is turned on or the image forming apparatus 100 is restarted, etc.

In step S702a, the power control unit 305 of the controller unit 120 starts supplying power to, for example, the operation unit 110, and turns on the power of the operation unit 110.

In step S702b, the power control unit 305 of the controller unit 120 starts supplying power to, for example, the engine unit 130, and turns on the power of the engine unit 130.

In steps S703a through S705a, the assurance time acquiring unit 306 of the controller unit 120 acquires a power off assurance time 1 of the operation unit 110 from the operation unit 110, and stores the power off assurance time 1 in the assurance time storage unit 307.

For example, in step S703a, the assurance time acquiring unit 306 of the controller unit 120 sends a request to acquire the power off assurance time 1 to the operation unit 110.

In step S704a, the assurance time acquiring unit 306 of the controller unit 120 acquires the power off assurance time 1 from the operation unit 110.

In step S705a, the assurance time storage unit 307 of the controller unit 120 stores the power off assurance time 1 acquired from the operation unit 110, for example, as the “power off assurance time” corresponding to the device “operation unit” in Table 1.

Similarly, in steps S703b through S705b, the assurance time acquiring unit 306 of the controller unit 120 acquires a power off assurance time 2 of the engine unit 130 from the engine unit 130, and stores the power off assurance time 2 in the assurance time storage unit 307.

For example, in step S703b, the assurance time acquiring unit 306 of the controller unit 120 sends a request to acquire the power off assurance time 2 to the engine unit 130.

In step S704b, the assurance time storage unit 307 of the controller unit 120 acquires the power off assurance time 2 from the engine unit 130.

In step S705b, the assurance time storage unit 307 of the controller unit 120 stores the power off assurance time 2 acquired from the engine unit 130, for example, as the “power off assurance time” corresponding to the device “engine unit” in Table 1.

By the above process, the controller unit 120 can acquire the power off assurance time from each device (the operation unit 110 and the engine unit 130), and store the acquired power off assurance time in the assurance time storage unit 307. Accordingly, for example, when a new engine unit 130 is added to the image forming apparatus 100 by plug-in, or when the engine unit 130 has been replaced in a maintenance operation, etc., the controller unit 120 can easily add or update the power off assurance time of the engine unit 130.

### Third Embodiment

In a third embodiment, a description is given of an example in which, when the error detecting unit 302 of the controller unit 120 detects a predetermined abnormality, a restart process is executed according to settings set by the administrator or a user, etc., in advance.

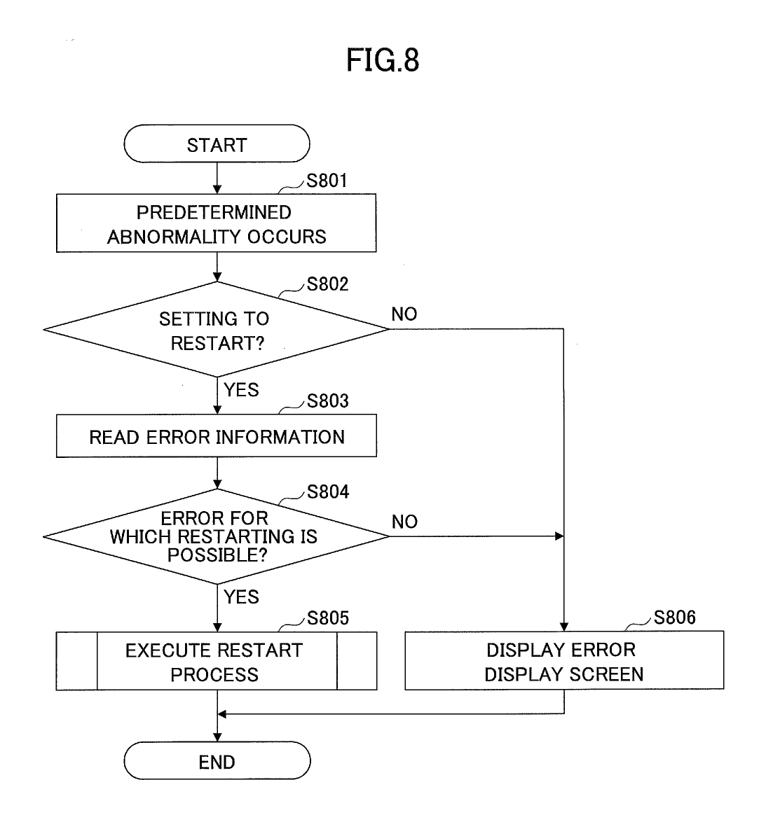

FIG. 8 is a flowchart indicating an example of a process performed when an error occurs according to the third embodiment. Note that it is assumed that, at the starting time point in FIG. 8, a setting value, which indicates whether to restart when a predetermined abnormality occurs, has been set in advance with the use of the operation unit 110, etc., by the administrator or the user, etc., of the image forming apparatus 100.

In step S801, for example, it is assumed that a predetermined abnormality (for example, a fatal error at the kernel level, etc.) has occurred at the controller unit 120.

In step S802, for example, when the error detecting unit 302 detects that a predetermined abnormality has occurred, the device control unit 308 of the controller unit 120 determines whether a setting to restart when a predetermined abnormality occurs has been made.

When a setting to restart when a predetermined abnormality occurs has been made, the device control unit 308 shifts the process to step S803. On the other hand, when a setting to restart when a predetermined abnormality occurs has not been made, the device control unit 308 shifts the process to step S806.

When the process shifts to step S803, the device control unit 308 of the controller unit 120 reads error information, for example, as indicated in Table 2, stored in the error information storage unit 304.

TABLE 2

| | ERROR | WHETHER | |
|---|---|---|---|
| ERROR CONTENT | CODE | TO RESTART | . . . |
| INCONSISTENCY | xxx-xx01 | YES | . . . |
| WITH CONTROL VALUE | | | |
| (CANNOT BE RECOVERED) | | | |
| COMMUNICATION ERROR | xxx-xx02 | YES | . . . |
| WITH PLURAL DEVICES | | | |
| . | . | . | . |
| . | . | . | . |
| . | . | . | . |
| COMMUNICATION ERROR | yyy-yy11 | NO | . . . |
| WITH PARTICULAR DEVICE | | | |
| STORAGE DEVICE ERROR | yyy-yy12 | NO | . . . |
| . | . | . | . |
| . | . | . | . |
| . | . | . | . |

Table 2 indicates an example of the error information stored in the error information storage unit 304 according to the third embodiment.

In the example of Table 2, in the error information stored in the error information storage unit 304, an error code and information indicating whether to restart are stored for each error content.

The error code is identification information for identifying the error content. For example, the person, who is in charge of performing maintenance on the image forming apparatus 100 at a failure/maintenance center, etc., can identify the error content based on the error code conveyed from a user, etc.

Information indicating whether to restart is information set in advance indicating whether to resume operations, for example, according to whether the error content indicates an error that can be recovered by restarting, or an error by which data may be damaged by restarting such as a failure of the HDD 126, etc.

For example, in the example of Table 2, “communication error with particular device” is likely to be an error at the device, and therefore “NO” is set as the information indicating whether to restart, such that the image forming apparatus 100 is not restarted and an attempt is made to restart the device. On the other hand, “communication error with a plurality of devices” is likely to be an error that cannot be recovered by restarting the respective devices, and therefore “YES” is set as the information indicating whether to restart. Note that the error information indicated in Table 2 is merely an example.

Referring back to FIG. 8, the description of the flowchart is continued.

In step S804, the device control unit 308 of the controller unit 120 uses the error information read from the error information storage unit 304 to determine whether the error detected by the error detecting unit 302 is an error for which restarting is possible.

When the detected error is an error for which restarting is possible (information indicating whether to restart is “YES”), the device control unit 308 of the controller unit 120 shifts the process to step S805. On the other hand, when the detected error is an error for which restarting is not possible (information indicating whether to restart is “NO”), the device control unit 308 of the controller unit 120 shifts the process to step S806.

When the process shifts to step S805, for example, the controller unit 120 executes the restart process illustrated in FIG. 4.

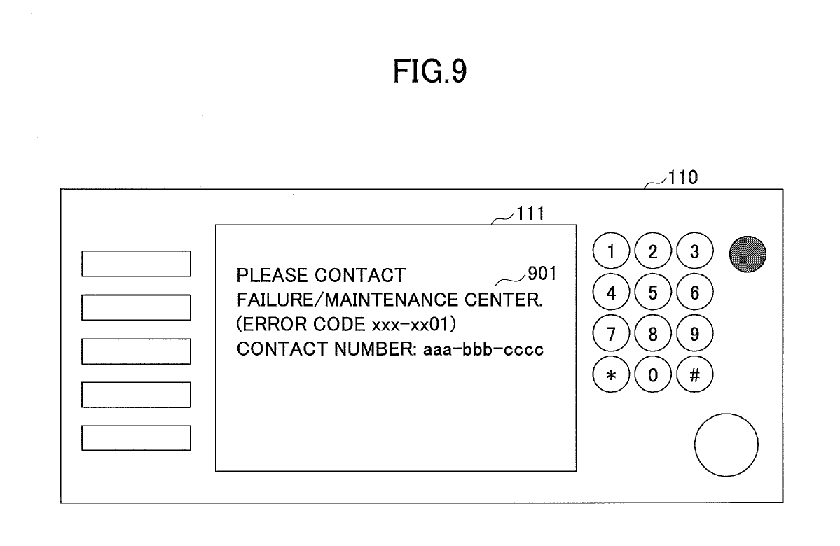

When the process shifts to step S806, for example, the device control unit 308 of the controller unit 120 displays an error display screen as illustrated in FIG. 9, on the operation unit 110.

FIG. 9 illustrates an example of an error display screen according to the third embodiment. In the example of FIG. 9, a message 901 indicating that an error has occurred is displayed on the display unit 111 of the operation unit 110.

By this message 901, for example, the image forming apparatus 100 can report to the administrator or the user, etc., that an error, which cannot be automatically recovered by restarting the image forming apparatus 100, has occurred, and prompt the administrator or the user to contact the failure/maintenance center.

As described above, the image forming apparatus 100 according to the present embodiment can set a setting value indicating whether to restart when a fatal error occurs.

Furthermore, when the error that has occurred can be recovered by restarting, the image forming apparatus 100 executes the restart process. When the error that has occurred cannot be recovered by restarting, the image forming apparatus 100 avoids restarting and prompts the administrator or the user to contact the failure/maintenance center.

In the image forming apparatus 100 according to the present embodiment, when an abnormality occurs at the controller unit in an electronic device including one or more devices and the controller unit, the controller unit can collaborate with each of the devices and safely restart the electronic device.

### OTHER EMBODIMENTS

In the above descriptions, the electronic device is the image forming apparatus 100 and the one or more devices are the operation unit 110 and the engine unit 130; however, for example, the configuration of the image forming apparatus 100 illustrated in FIG. 1 is an example of a configuration of an electronic device.

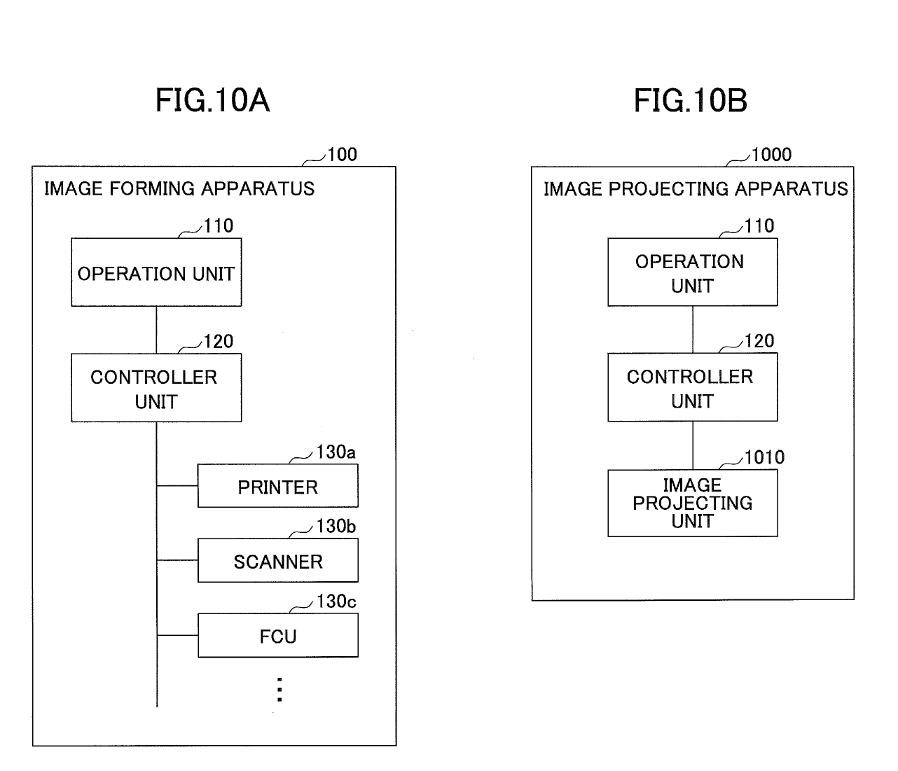

For example, as illustrated in FIG. 10A, the engine unit 130 of the image forming apparatus 100 may be divided into a plurality of devices such as a printer 130a, a scanner 130b, and an FCU 130c, etc.

Furthermore, for example, the electronic device may be an electronic device other than the image forming apparatus 100, such as an image projecting apparatus 1000 illustrated in FIG. 10B. In the example of FIG. 10B, the image projecting apparatus 1000 includes an image projecting unit 1010 instead of the printer 130a, the scanner 130b, and the FCU 130c in the image forming apparatus 100 illustrated in FIG. 10A.

For example, the image projecting unit 1010 includes a light source for projecting images. In the image projecting apparatus 1000, the temperature of the light source increases while projecting images, and therefore after finishing the projection of images, the power source is continuously cooled with a fan until the temperature of the light source decreases to less than or equal to a predetermined value. Thus, a predetermined amount of time is required until the power can be turned off.

In this case, the image projecting unit 1010 stores in advance a power off assurance time according to the light source. The controller unit 120 of the image projecting apparatus 1000 acquires the power off assurance time from the image projecting unit 1010. When a predetermined abnormality occurs, a power off preparation signal is output. After the acquired power off assurance time has passed from when the power off preparation signal has been output, the power supplied to the image projecting unit 1010 is to be cut off. Accordingly, the controller unit 120 of the image forming apparatus 100 can restart the image forming apparatus 100 by using the power off assurance time according to the light source of the image projecting unit 1010.

According to one embodiment of the present invention, in an electronic device including one or more devices and a controller unit, even when an abnormality occurs at the controller unit, the controller unit can collaborate with the respective devices to restart the electronic device.

The electronic device and the power control method are not limited to the specific embodiments described in the detailed description, and variations and modifications may be made without departing from the spirit and scope of the present invention.

What is claimed is:

1. An electronic device comprising:
a controller coupled to a device via a signal line, the controller including:
an outputter configured to output a predetermined signal to the device by using the signal line, when a predetermined abnormality occurs at the controller; and
a power controller configured to control an operation of cutting off power supplied to the device, after a predetermined assurance time has passed from when the predetermined signal has been output.

2. The electronic device according to claim 1, wherein the predetermined abnormality includes an error requiring to restart the electronic device or the controller.

3. The electronic device according to claim 1, wherein the predetermined assurance time includes a time that is set in advance to assure that the power supplied to the device can be safely cut off.

4. The electronic device according to claim 1, wherein the controller includes an acquirer configured to acquire the predetermined assurance time of the device, from the device.

5. The electronic device according to claim 1, wherein
the electronic device includes a plurality of the devices, and
the electronic device includes an assurance time storage configured to store the predetermined assurance time for each of the plurality of the devices.

6. The electronic device according to claim 5, wherein
the outputter outputs the predetermined signal to the plurality of the devices, when the predetermined abnormality occurs at the controller, and
the power controller controls an operation of cutting off the power supplied to the plurality of the devices, based on the predetermined assurance time of each of the plurality of the devices stored in the assurance time storage.

7. The electronic device according to claim 6, further comprising:
a device controller configured to execute a restart process of restarting the electronic device or the controller, after the power controller cuts off the power supplied to the plurality of the devices.

8. The electronic device according to claim 7, further comprising:
an error information storage configured to store one or more of the predetermined abnormalities that occur at the controller, and information indicating whether to execute the restart process with respect to each of the one or more of the predetermined abnormalities, and
the device controller executes the restart process with respect to the electronic device, based on the information stored in the error information storage.

9. The electronic device according to claim 1, wherein the device executes an ending process of shifting to a state in which the power supplied to the device can be cut off, according to the predetermined signal.

10. A power control method executed by an electronic device including a controller coupled to a device via a signal line, the power control method including:
outputting, by the controller, a predetermined signal to the device by using the signal line, when a predetermined abnormality occurs at the controller; and
controlling, by the controller, an operation of cutting off power supplied to the device, after a predetermined assurance time has passed from when the predetermined signal has been output.
